(19) United States
(12) Patent Application Publication
(10) Pub. No.: US 2013/0167065 A1
(43) Pub. Date: Jun. 27, 2013

(54) ELECTRONIC DEVICE AND METHOD FOR MANAGING ICONS OF HOME SCREEN OF THE ELECTRONIC DEVICE

(71) Applicants: PEI-JU CHEN, Tu-Cheng (TW); PEI-HSI CHENG, Tu-Cheng (TW); YUN-JU CHEN, Tu-Cheng (TW); SHU-YUN HUANG, Tu-Cheng (TW); CHUN-CHIH YU, Tu-Cheng (TW)

(72) Inventors: PEI-JU CHEN, Tu-Cheng (TW); PEI-HSI CHENG, Tu-Cheng (TW); YUN-JU CHEN, Tu-Cheng (TW); SHU-YUN HUANG, Tu-Cheng (TW); CHUN-CHIH YU, Tu-Cheng (TW)

(73) Assignee: CHI MEI COMMUNICATION SYSTEMS, INC., Tu-Cheng (TW)

(21) Appl. No.: 13/461,744

(22) Filed: May 1, 2012

(30) Foreign Application Priority Data
Dec. 27, 2011 (TW) 100149039

(51) Int. Cl. G06F 3/048

(52) U.S. Cl. 715/777

(57) ABSTRACT

A method for managing icons of a home screen using an electronic device displays a tab widget to switch among panels of the home screen on a touchscreen of the electronic device. The tab widget including customized icons that represent the plurality of panels correspondingly. The tab widget is displayed on each of the panels of the home screen. A dragging operation on a target icon of a current panel of the home screen is detected. A target panel is determined if the target icon has been dragged to one of the customized icons in the tab widget, and the target panel corresponds to the customized icon. The target icon is moved from the current panel to the target panel if the target panel is not the current panel and the target panel has enough display space to position the target icon.

### BACKGROUND

1. Technical Field

Embodiments of the present disclosure relate to interface management technology, and particularly to an electronic device and method for managing icons of a home screen of the electronic device.

2. Description of Related Art

An electronic device provides a home screen to display a plurality of icons (or buttons) of different applications. The home screen may have several panels to show different kinds of icons. For example, a first panel of the home screen may provide icons of communication applications, such as a phone book, a dial, and communication records. The icons may be moved between the panels of the home screen according to user favorites. However, if a selected icon needs to be moved to another panel, a user has to pick up the selected icon, and slide the selected icon over a side of a touchscreen of the electronic device, then wait for the touchscreen to shift to a target panel of the home screen. That is, it is inefficient to move the selected icon from a current panel to the target panel.

### BRIEF DESCRIPTION OF THE DRAWINGS

FIG. 1 is a block diagram of one embodiment of an electronic device including a management system.

FIGS. 2-4 are schematic diagrams of one embodiment of a home screen on a touchscreen of the electronic device of FIG. 1.

FIG. 5 is a flowchart of one embodiment of a method for managing icons of the home screen using the management system of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

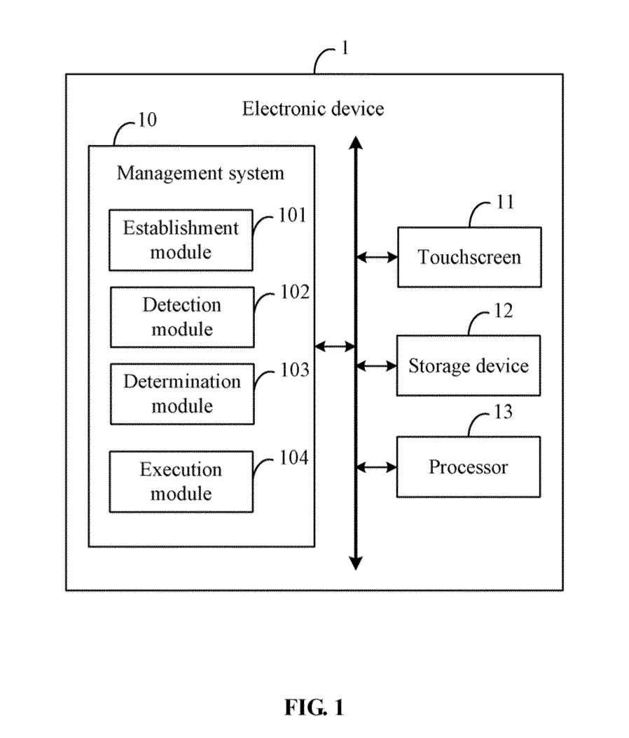

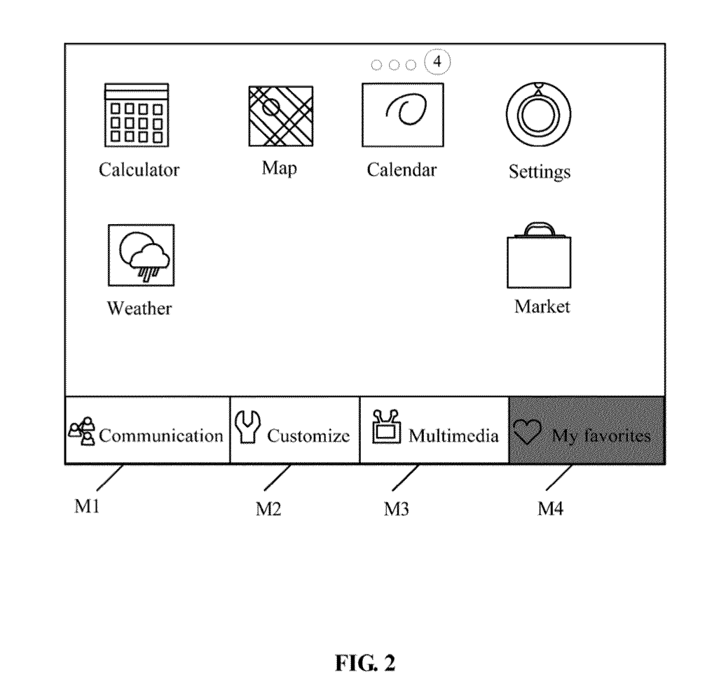

FIG. 1 is a block diagram of one embodiment of an electronic device 1 including a management system 10. The electronic device 1 may be a cell phone, a personal digital assistant, a tablet computer, or any other computing device. The electronic device 1 includes a touchscreen 11. The touchscreen 11 is used to input and output relevant data, such as images, or files, for example. In some embodiments, the touchscreen 11 may be a capacitive touchscreen or a resistive touchscreen that offers a multi-touch capability. As shown in FIG. 2, the touchscreen 11 provides a home screen having a plurality of home screen panels (hereinafter referred to as “panels”), to display icons of different applications or files of the electronic device 1.

In some embodiments, the management system 10 displays a tab widget including a plurality of customized icons on the touchscreen 11. In some embodiments, the tab widget is a graphical user interface displayed on the touchscreen 11 that allows selection of one panel of the home screen by a user using the customized icons. Each of the customized icons corresponds to each of the panels of the home screen. The management system 10 can move one or more icons of corresponding applications (e.g., a media player, a calculator) of the electronic device 1 from an original panel of the home screen to another panel of the home screen by detecting user operations on the tab widget. A detailed description of the management system 10 will be given in the following paragraphs.

The electronic device 1 further includes a storage device 12 providing one or more memory functions, and at least one processor 13. In one embodiment, the management system 10 may include computerized instructions in the form of one or more programs that are executed by the at least one processor 13 and stored in the storage device 12.

The storage device 12 stores one or more programs, such as programs of the operating system, other applications of the electronic device 1, and various kinds of data, such as videos and images. In some embodiments, the storage device 12 may include a memory of the electronic device 1 and/or an external storage card, such as a memory stick, a smart media card, a compact flash card, or any other type of memory card. FIG. 1 illustrates only one example of the electronic device 1 that may include more or fewer components than as illustrated, or have a different configuration of the various components.

In one embodiment, the management system 10 may include one or more modules, for example, an establishment module 101, a detection module 102, a determination module 103, and an execution module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The establishment module 101 displays the tab widget on each of the plurality of panels of the home screen on the touchscreen 11. The tab widget includes customized icons, each of the customized icons represents a corresponding panel of the home screen. The user of the electronic device 1 may utilize the tab widget to switch a current panel of the home screen to another panel. For example, the detection module 102 detects that a customized icon in the tab widget on the touchscreen 11 has been clicked by a finger of the user or a stylus, and the determination module 103 determines a specific panel corresponding to the customized icon is not a current panel. Then the execution module 104 switches the current panel of the home screen to the selected panel, and displays the selected panel on the touchscreen 11.

As mentioned above, each of the panels of the home screen has a plurality of icons corresponding to different applications (e.g., a calendar, a phone book). In some embodiments, the panels may be distinguished according to user customizations.

As shown in FIG. 2, the home screen has four panels (although not limited to four), such as a first panel referred to communication applications (e.g., messages, a phone book, communication records), a second panel referred to customized applications (e.g., weather forecast), a third panel referred to multimedia applications (e.g., a media player, a recorder, songs, images, videos), and a fourth panel referred to “my favorites” applications (e.g., games, the messages, a map). FIG. 2 provides a tab widget including four customized icons (e.g., M1, M2, M3, and M4) that correspond to the panels of the home screen of the electronic device 1. The tab widget in FIG. 2 has been established and displayed on each panel of the home screen. The customized icon M1 represents the first panel of the home screen, the customized icon M2 represents the second panel, the customized icon M3 represents the third panel, and the customized icon M4 represents the fourth panel. Each customized icon may include a customized name (e.g., “communication” of M1 in FIG. 2) and an image, for example.

The establishment module 101 may preset a position of the tab widget on each panel of the home screen. For example, the tab widget in FIG. 2 is displayed on the bottom of each panel.

The detection module 102 detects a dragging operation on a target icon of the current panel of the home screen. For example, the user may use the finger or the stylus to click an icon of an application displayed on the current panel on the touchscreen 11, then drag or slide the icon to a target position, this icon is regarded as the target icon. In other embodiments, the detection module 102 may predetermine a specific operation, such as a press operation on the target icon for a predetermined time (e.g., 2 seconds) and a dragging operation to drag the target icon to the target position.

The determination module 103 determines if the target icon has been dragged to one of customized icons in the tab widget.

If the target icon has not been dragged to the tab widget, the execution module 104 determines a release position of the target icon on the current panel, and moves the target icon on the release position. The release position is different from an original position of the target icon.

If the target icon has been dragged to one of the customized icons in the tab widget, that is, the target position is the customized icon, the determination module 103 determines a target panel corresponding to the customized icon.

The determination module 103 further determines if the target panel is the current panel. If the target is the current panel, the execution module 104 pops up a failed message on the touchscreen 11 for reminding that the target icon cannot be moved to any other positions. If the target is not the current panel, the determination module 103 further determines if the target panel has enough display space to position the target icon. In some embodiments, the display space of the target panel or any other panel of the home screen on the touchscreen 11 is used to position icons of different application of the electronic device 1. For example, the display space of the target panel may contain nine icons.

If the target panel has enough display space to position the target icon, the execution module 104 moves the target icon from the current panel to the target panel. In detailed, the execution module 104 deletes the target icon from the current panel of the home screen, and switches the current panel to the target panel. If the target icon has been released on the customized icon of the target panel in the tab widget, the execution module 104 positions the target icon on the target panel automatically. That is, the target icon is positioned on the target panel according to a default sequence of the home screen, for example, the target icon is positioned before or after the other icons on the target panel. If the target icon has been released on a target position of the target panel, the execution module 104 positions the target icon on the target position of the target panel.

If the target panel has not enough display space to position the target icon, the execution module 104 provides a reminder message on the touchscreen 11 that reminds the user to delete one or more icons on the target panel before moving the target icon.

As shown in FIG. 2, the current panel of the home screen is the fourth panel having a customized name “my favorites”, and the customized icon of the current panel is M4. A plurality of icons corresponding to different applications are shown on the current panels, such as a calculator icon, a map icon, a calendar icon, a settings icon, a weather icon, and a market icon.

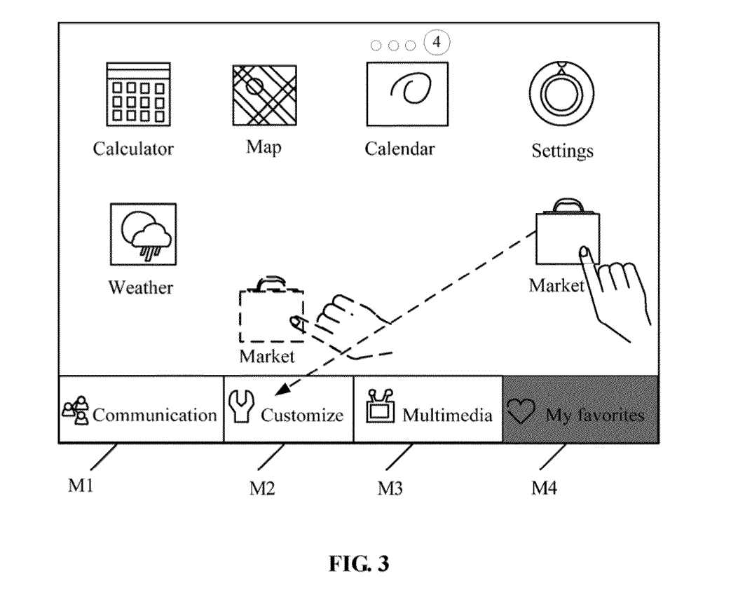

As shown in FIG. 3, the market icon is clicked and dragged to the customized icon M2, which corresponds to the second panel having the customized name “customized”. The second panel is regarded as the target panel.

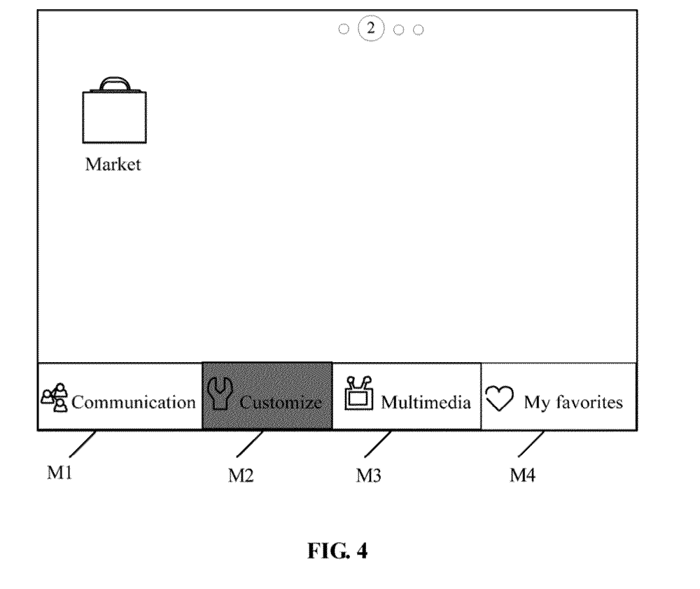

As shown in FIG. 4, the market icon has been moved to the second panel of the home screen.

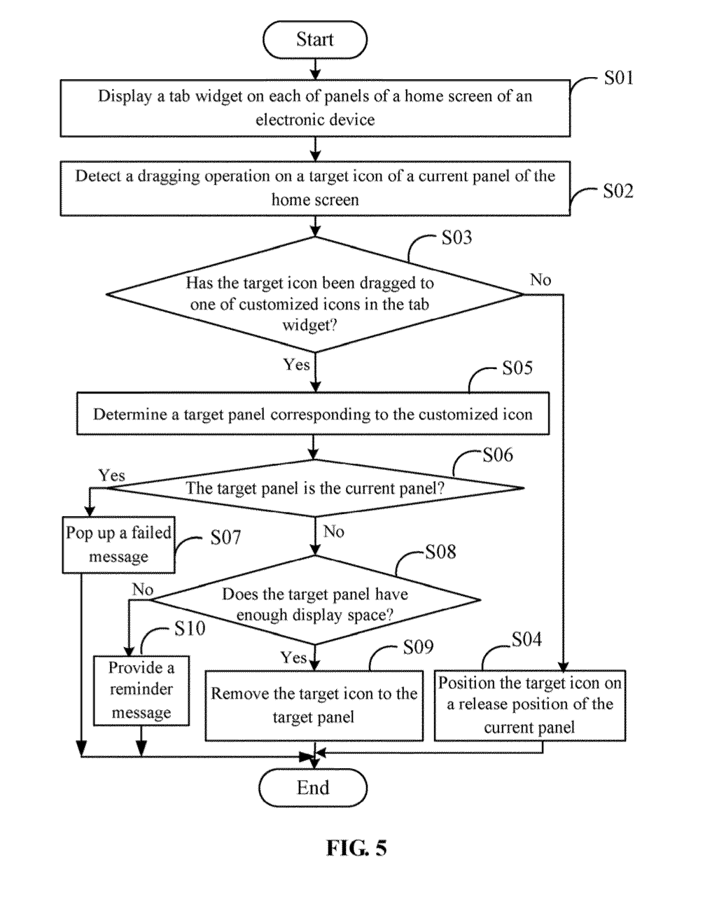

FIG. 5 is a flowchart of one embodiment of a method for managing icons of the home screen of the electronic device 1 using the management system 10 of FIG. 1. Depending on the embodiment, additional steps may be added, others moved, and the ordering of the steps may be changed.

In step S01, the establishment module 101 displays a tab widget on each of the plurality of panels of the home screen on the touchscreen 11, the tab widget is used to switch among the plurality of panels of the home screen. As mentioned above, the tab widget includes customized icons, each of the customized icons represents a corresponding panel of the home screen.

In step S02, the detection module 102 detects a dragging operation on a target icon of the current panel of the home screen.

In step S03, the determination module 103 determines if the target icon has been dragged to one of customized icons in the tab widget.

If the target icon has not been dragged to the tab widget, in step S04, the execution module 104 determines a release position of the target icon on the current panel, and moves the target icon on the release position.

If the target icon has been dragged to one of the customized icons in the tab widget, in step S05, the determination module 103 determines a target panel corresponding to the customized icon.

In step S06, the determination module 103 determines if the target panel is the current panel.

If the target is the current panel, in step S07, the execution module 104 pops up a failed message on the touchscreen 11 for reminding that the target icon cannot be moved to any other positions.

If the target is not the current panel, in step S08, the determination module 103 determines if the target panel has enough display space to position the target icon.

If the target panel has enough display space to position the target icon, in step S09, the execution module 104 moves the target icon from the current panel to the target panel.

If the target panel has not enough display space to position the target icon, in step S10, the execution module 104 provides a reminder message on the touchscreen 11 that reminds the user to delete one or more icons on the target panel before moving the target icon.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method of an electronic device comprising a touchscreen for managing icons of a home screen displayed on the touchscreen, the home screen having a plurality of panels, the method comprising execution of the steps comprising:
displaying a tab widget on each of the plurality of panels of the home screen, the tab widget comprising customized icons for switching among the plurality of panels of the home screen, and each of the customized icons representing one of the plurality of panels;
detecting a dragging operation on a target icon of a current panel of the home screen;
determining a target panel of the home screen, under the condition that the target icon has been dragged to one of the customized icons in the tab widget, the target panel corresponding to the customized icon; and
moving the target icon from the current panel to the target panel under the condition that the target panel is not the current panel and the target panel has enough display space to position the target icon.

2. The method according to claim 1, further comprising:
providing a reminder message on the touchscreen that reminds a user to delete one or more icons on the target panel, under the condition that the target panel does not have enough display space to position the target icon.

3. The method according to claim 1, further comprising:
popping up a failed message on the touchscreen for reminding that the target icon cannot be moved under the condition that the target panel is the current panel.

4. The method according to claim 1, further comprising:
moving the target icon on a release position of the current panel on the touchscreen under the condition that the target icon has not been dragged to one of the customized icons in the tab widget and has been released on the release position of the current panel on the touchscreen, the release position being different from an original position of the target icon.

5. The method according to claim 1, wherein the target icon is moved from the current panel to the target panel by:
deleting the target icon from the current panel of the home screen, and switching the current panel to the target panel; and
positioning the target icon on the target panel on the touchscreen automatically under the condition that the target icon has been released on the customized icon of the target panel; or
positioning the target icon on a target position of the target panel on the touchscreen, under the condition that the target icon has been released on the target position of the target panel.

6. The method according to claim 1, further comprising:
switching the current panel of the home screen to a selected panel and displaying the selected panel on the touchscreen, in response to detecting that a customized icon of the selected panel in the tab widget has been clicked.

7. An electronic device for managing icons of a home screen, the home screen having a plurality of panels, the electronic device comprising:
a touchscreen that displays the home screen;
a storage device;
at least one processor; and
one or more modules that are stored in the storage device and executed by the at least one processor, the one or more modules comprising:
an establishment module that displays a tab widget on each of the plurality of panels of the home screen, the tab widget comprising customized icons for switching among the plurality of panels of the home screen, and each of the customized icons representing one of the plurality of panels;
a detection module that detects a dragging operation on a target icon of a current panel of the home screen;
a determination module that determines a target panel of the home screen, under the condition that the target icon has been dragged to one of the customized icons in the tab widget, the target panel corresponding to the customized icon; and
an execution module that moves the target icon from the current panel to the target panel under the condition that the target panel is not the current panel and the target panel has enough display space to position the target icon.

8. The electronic device according to claim 7, wherein the execution module provides a reminder message on the touchscreen that reminds a user to delete one or more icons on the target panel, under the condition that the target panel has not enough display space to position the target icon.

9. The electronic device according to claim 7, wherein the execution module popping up a failed message on the touchscreen for reminding that the target icon cannot be moved under the condition that the target panel is the current panel.

10. The electronic device according to claim 7, wherein the execution module moves the target icon on a release position of the current panel on the touchscreen under the condition that the target icon has not been dragged to one of the customized icons in the tab widget and has been released on the release position of the current panel on the touchscreen, the release position being different from an original position of the target icon.

11. The electronic device according to claim 7, wherein the execution module moves the target icon from the current panel to the target panel by:
deleting the target icon from the current panel of the home screen, and switching the current panel to the target panel; and
positioning the target icon on the target panel on the touchscreen automatically under the condition that the target icon has been released on the customized icon of the target panel; or
positioning the target icon on a target position of the target panel on the touchscreen, under the condition that the target icon has been released on the target position of the target panel.

12. The electronic device according to claim 7, wherein the execution module switches the current panel of the home screen to a selected panel and displays the selected panel on the touchscreen, in response to detecting that a customized icon of the selected panel in the tab widget has been clicked.

13. A non-transitory storage medium having stored instructions that, when executed by a processor of an electronic device comprising a touchscreen, causes the electronic device to perform a method for managing icons of a home screen displayed on the touchscreen, the home screen having a plurality of panels, the method comprising:
displaying a tab widget on each of the plurality of panels of the home screen, the tab widget comprising customized icons for switching among the plurality of panels of the home screen, and each of the customized icons representing one of the plurality of panels;
detecting a dragging operation on a target icon of a current panel of the home screen;
determining a target panel of the home screen, under the condition that the target icon has been dragged to one of the customized icons in the tab widget, the target panel corresponding to the customized icon; and
moving the target icon from the current panel to the target panel under the condition that the target panel is not the current panel and the target panel has enough display space to position the target icon.

14. The non-transitory storage medium according to claim 13, wherein the method further comprises:
providing a reminder message on the touchscreen that reminds a user to delete one or more icons on the target panel, under the condition that the target panel has not enough display space to position the target icon.

15. The non-transitory storage medium according to claim 13, wherein the method further comprises:
popping up a failed message on the touchscreen for reminding that the target icon cannot be moved under the condition that the target panel is the current panel.

16. The non-transitory storage medium according to claim 13, wherein the method further comprises:
moving the target icon on a release position of the current panel on the touchscreen under the condition that the target icon has not been dragged to one of the customized icons in the tab widget and has been released on the release position of the current panel on the touchscreen, the release position being different from an original position of the target icon.

17. The non-transitory storage medium according to claim 13, wherein the target icon is moved from the current panel to the target panel by:
deleting the target icon from the current panel of the home screen, and switching the current panel to the target panel; and
positioning the target icon on the target panel on the touchscreen automatically under the condition that the target icon has been released on the customized icon of the target panel; or
positioning the target icon on a target position of the target panel on the touchscreen, under the condition that the target icon has been released on the target position of the target panel.

18. The non-transitory storage medium according to claim 13, wherein the method further comprises:
switching the current panel of the home screen to a selected panel and displaying the selected panel on the touchscreen, in response to detecting that a customized icon of the selected panel in the tab widget has been clicked.
